(19) United States
(12) Patent Application Publication
(10) Pub. No.: US 2026/0066267 A1
(43) Pub. Date: Mar. 5, 2026

(54) ELECTRODE FOR SECONDARY BATTERY AND SECONDARY BATTERY INCLUDING SAME

(71) Applicant: Samsung SDI Co., Ltd., Yongin-si (KR)

(72) Inventors: Kwangjo CHEONG, Yongin-si (KR); Kyugil CHOI, Yongin-si (KR)

(21) Appl. No.: 19/071,547

(22) Filed: Mar. 5, 2025

(30) Foreign Application Priority Data
Sep. 5, 2024 (KR) 10-2024-0120586

(51) Int. Cl. H01M 4/13; H01M 4/02; H01M 4/66; H01M 10/0587; H01M 10/42; H01M 50/533; H01M 50/586; H01M 50/59

(52) U.S. Cl. CPC H01M 4/13; H01M 4/661; H01M 4/667; H01M 10/0587; H01M 10/4235; H01M 50/533; H01M 50/586; H01M 50/59; H01M 2004/027; H01M 2004/028

(57) ABSTRACT

An electrode for a secondary battery includes a composite substrate including a first substrate and a second substrate, each of the first substrate and the second substrate including a conductive metal material, and an insulating layer between the first substrate and the second substrate, a first active material layer on the first substrate of the composite substrate, a second active material layer on the second substrate of the composite substrate, a first electrode tab coupled to the first substrate of the composite substrate, and a second electrode tab coupled to the second substrate of the composite substrate.

### CROSS-REFERENCE TO RELATED APPLICATION

The present application claims priority to and the benefit of Korean Application No. 10-2024-0120586, filed on Sep. 5, 2024, in the Korean Intellectual Property Office, the entire disclosure of which is incorporated by reference herein.

### BACKGROUND

### 1. Technical Field

Aspects and features of embodiments of the present disclosure relate to an electrode for a secondary battery and a secondary battery including the same.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

A variety of research and development are actively being conducted to reduce the weight of lithium secondary battery components and improve the energy density, capacity, and safety of batteries.

The above information disclosed in this Background section is for enhancement of understanding of the background of the present disclosure, and therefore, it may contain information that does not constitute related (or prior) art.

### SUMMARY

Embodiments of the present disclosure provide an electrode for a secondary battery and a secondary battery including the same.

These and other aspects and features of the present disclosure will be described in or will be apparent from the following description of embodiments of the present disclosure.

However, aspects and features of the present disclosure are not limited to those described above, and other aspects and features not mentioned will be clearly understood by a person skilled in the art from the detailed description, described below.

According to one or more embodiments of the present disclosure, an electrode for a secondary battery includes a composite substrate including a first substrate and a second substrate, each of the first substrate and the second substrate including a conductive metal material, and an insulating layer between the first substrate and the second substrate, a first active material layer on the first substrate of the composite substrate, a second active material layer on the second substrate of the composite substrate, a first electrode tab coupled to the first substrate of the composite substrate, and a second electrode tab coupled to the second substrate of the composite substrate.

According to one or more embodiments of the present disclosure, the first electrode tab and the second electrode tab may be at different positions with respect to a longitudinal direction of the composite substrate.

According to one or more embodiments of the present disclosure, at least a portion of the first electrode tab may protrude from one side of the composite substrate, and at least a portion of the second electrode tab may protrude from one side of the composite substrate.

According to one or more embodiments of the present disclosure, the first electrode tab may include a first protrusion, at least a portion of the first protrusion protruding from one side of the composite substrate, the second electrode tab may include a second protrusion, at least a portion of the second protrusion protruding from one side of the composite substrate, and a length of the first protrusion may be different from a length of the second protrusion.

According to one or more embodiments of the present disclosure, the length of the first protrusion may be longer than the length of the second protrusion, and the second protrusion may be coupled to the first protrusion so that the first electrode tab and the second electrode tab are electrically connected to a terminal or a lead tab.

According to one or more embodiments of the present disclosure, the first active material layer may include a 1_1 active material layer and a 1_2 active material layer, the second active material layer may include a 2_1 active material layer and a 2_2 active material layer, the first electrode tab may be located between the 1_1 active material layer and the 1_2 active material layer, and the second electrode tab may be located between the 2_1 active material layer and the 2_2 active material layer.

According to one or more embodiments of the present disclosure, the first electrode tab may be located at one end with respect to a longitudinal direction of the composite material, and the second electrode tab may be located at another end with respect to the longitudinal direction of the composite material.

According to one or more embodiments of the present disclosure, the first electrode tab may be electrically connected to the first active material layer, and the second electrode tab may be electrically connected to the second active material layer.

According to one or more embodiments of the present disclosure, the insulating layer may include at least one of PET, PP, PE, PS, PI, or PU.

According to one or more embodiments of the present disclosure, the first electrode tab may include a first joined portion coupled to the composite substrate, the second electrode tab may include a second joined portion coupled to the composite substrate, and the electrode may further include a protection tape covering each of the first joined portion and the second joined portion.

According to one or more embodiments of the present disclosure, an electrode for a secondary battery includes a composite substrate including a first substrate and a second substrate, each of the first substrate and the second substrate including a conductive metal material, and an insulating layer between the first substrate and the second substrate, wherein the first substrate includes a first uncoated portion on one side of the first substrate, the second substrate includes a second uncoated portion on one side of the second substrate, and the first uncoated portion and the second uncoated portion face each other, a first active material layer on the first substrate of the composite substrate, a second active material layer on the second substrate of the composite substrate, and a plurality of segmented portions formed by joining and segmenting the first uncoated portion and the second uncoated portion.

According to one or more embodiments of the present disclosure, the segmented portions may be associated with electrical connection between the first active material layer and the second active material layer.

According to one or more embodiments of the present disclosure, the insulating layer may include at least one of PET, PP, PE, PS, PI, or PU.

According to one or more embodiments of the present disclosure, a secondary battery includes an electrode assembly including a positive electrode, a negative electrode and a separator, and a case configured to accommodate the electrode assembly, wherein the positive electrode includes, a first composite substrate including a first substrate and a second substrate, each of the first substrate and the second substrate including a conductive metal material, and an insulating layer between the first substrate and the second substrate, a first active material layer on the first substrate of the first composite substrate, a second active material layer on the second substrate of the first composite substrate, a first electrode tab coupled to the first substrate of the first composite substrate, and a second electrode tab coupled to the second substrate of the first composite substrate, wherein the negative electrode includes, a second composite substrate including a third substrate and a fourth substrate, each of the third substrate and the fourth substrate including a conductive metal material, and an insulating layer between the third substrate and the fourth substrate, wherein the third substrate includes a first uncoated portion on one side of the third substrate, the fourth substrate includes a second uncoated portion on one side of the fourth substrate, and the first uncoated portion and the second uncoated portion face each other, a third active material layer on the third substrate of the second composite substrate, a fourth active material layer on the fourth substrate of the second composite substrate, and a plurality of segmented portions formed by joining and segmenting the first uncoated portion and the second uncoated portion.

According to one or more embodiments of the present disclosure, a thickness of the negative electrode may be less than a thickness of the positive electrode.

According to one or more embodiments of the present disclosure, the electrode assembly may be formed by winding the positive electrode and the negative electrode, and the first electrode tab and the second electrode tab may face each other.

According to one or more embodiments of the present disclosure, the first electrode tab and the second electrode tab may be at different positions with respect to a longitudinal direction of the composite substrate.

According to one or more embodiments of the present disclosure, at least a portion of the first electrode tab may protrude from one side of the composite substrate, and at least a portion of the second electrode tab may protrude from one side of the composite substrate.

According to one or more embodiments of the present disclosure, the manufacturing cost of secondary batteries may be reduced because the weight and amount of metal used are reduced by the composite substrate, compared to a case where a general metal substrate is used. In addition, due to the composite substrate, a short circuit is effectively controlled even in a case where damage such as penetration of the battery occurs, thereby improving the stability and life characteristics of the secondary battery.

According to one or more embodiments of the present disclosure, one electrode tab may be coupled to each different surface of the electrode including the composite substrate. In a case where the electrodes are wound to form a jelly roll, the number of times the electrode tabs are welded and the number of times the welding protection tapes are used may be optimized, thereby improving the efficiency and productivity of the secondary battery. In addition, the thickness of the jelly roll used in the pouch-type or prismatic-type secondary battery may be reduced, thereby improving the energy density of the secondary battery.

According to one or more embodiments of the present disclosure, the segmented portions may be formed by joining and segmenting opposite uncoated portions on one side of different surfaces of the electrode including the composite substrate. In a case where the electrodes are wound to form a jelly roll, the number of times the electrode tabs are welded and the number of times the welding protection tapes are used may be minimized, thereby improving the efficiency and productivity of the secondary battery. In addition, the outer diameter of the jelly roll used in the cylindrical-type secondary battery may be reduced, thereby improving the energy density of the secondary battery.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates a secondary battery having a multi-tab structure according to one or more embodiments of the present disclosure.

FIG. 2 schematically illustrates an electrode for a secondary battery according to one or more embodiments of the present disclosure.

FIG. 3 illustrates an electrode for a secondary battery according to one or more embodiments (e.g., a first embodiment) of the present disclosure.

FIG. 4 illustrates an electrode for a secondary battery according to one or more embodiments (e.g., a second embodiment) of the present disclosure.

FIG. 5 illustrates an electrode for a secondary battery according to one or more embodiments (e.g., a third embodiment) of the present disclosure.

FIG. 6 illustrates an electrode for a secondary battery according to one or more embodiments (e.g., a fourth embodiment) of the present disclosure.

FIG. 7 illustrates an electrode assembly for a secondary battery according to one or more embodiments of the present disclosure.

FIG. 8 illustrates a secondary battery having a multi-tab structure according to one or more embodiments of the present disclosure.

FIG. 9 illustrates an electrode assembly for a secondary battery according to one or more embodiments of the present disclosure.

FIG. 10 illustrates an electrode assembly for a secondary battery according to one or more embodiments (e.g., the fourth embodiment) of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements. In addition, it will be understood that when a component is referred to as being “linked,” “coupled,” or “connected” to another component, the elements may be directly “coupled,” “linked” or “connected” to each other, or another component may be “interposed”between the components”.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

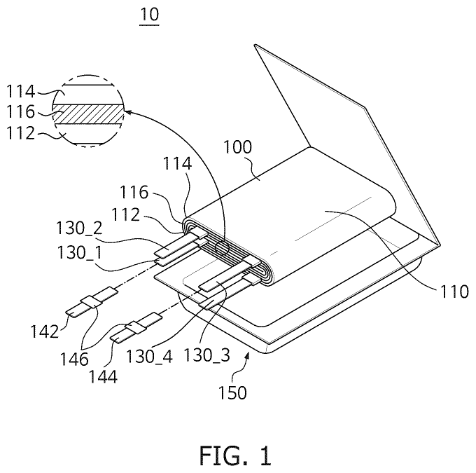

FIG. 1 illustrates a secondary battery 10 having a multi-tab structure according to one or more embodiments of the present disclosure. As illustrated in FIG. 1, the secondary battery 10 may include a case 150 and an electrode assembly 100 disposed inside the case 150.

The electrode assembly 100 may include an electrode stack 110. The electrode stack 110 may include a first electrode 112, a second electrode 114, and a separator 116 provided therebetween. The first electrode 112 and the second electrode 114 may be wound with the separator 116, which is an insulator, provided therebetween. In the electrode stack 110, the first electrode 112 may serve as a negative electrode and the second electrode 114 may serve as a positive electrode. However, the present disclosure is not limited thereto and the opposite is also possible.

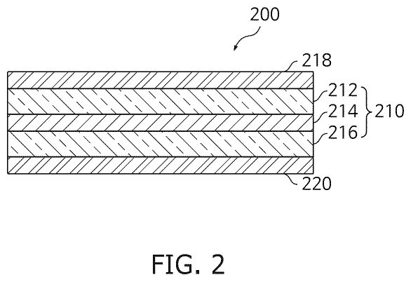

For example, the first electrode 112 may be formed by applying an active material, such as graphite and/or carbon, on a substrate in which an insulating layer made of an insulating material and/or polymer, such as polyethylene terephthalate (PET), polypropylene (PP), polyethylene (PE), poly sulfide (PS), polyimide (PI), and polyurethane (PU), is disposed between a first substrate and a second substrate made of a metal foil, such as copper, a copper alloy, nickel, and/or a nickel alloy (hereinafter, the substrate having such a structure is referred to as a “composite substrate”). Details regarding the composite substrate are described below with reference to FIG. 2. In one or more embodiments, the first electrode 112 may include an uncoated portion, which is a region where an active material is not applied, and a first electrode tab 130_1 and a second electrode tab 130_2 may be joined (e.g., coupled) to the uncoated portion of the first electrode 112. The first electrode tab 130_1 and the second electrode tab 130_2 may have different lengths. The first electrode tab 130_1 and the second electrode tab 130_2 may be joined to each other to form a current flow path between the first electrode 112 and a first lead tab 142. A tab film 146 for insulation from the case 150 may be attached to the first lead tab 142.

For example, the second electrode 114 may be formed by applying an active material, such as a transition metal oxide, on a composite substrate in which an insulating layer made of an insulating material and/or polymer, such as PET, PP, PE, PS, PI, and PU, is disposed between a first substrate and a second substrate made of a metal foil, such as aluminum or an aluminum alloy. Details regarding the composite substrate are described below with reference to FIG. 2. In one or more embodiments, the second electrode 114 may include an uncoated portion, which is a region where an active material is not applied, and a third electrode tab 130_3 and a fourth electrode tab 130_4 may be joined to the uncoated portion of the second electrode 114. The third electrode tab 130_3 and the fourth electrode tab 130_4 may have different lengths. The third electrode tab 130_3 and the fourth electrode tab 130_4 may be joined to each other to form a current flow path between the second electrode 114 and a second lead tab 144. The tab film 146 for insulation from the case 150 may be attached to the second lead tab 144.

The case 150 may form the overall exterior of the secondary battery 10 and may be made of a conductive metal, such as aluminum, an aluminum alloy, and/or nickel-plated steel. In one or more embodiments, the case 150 may provide a space in which the electrode stack 110 is accommodated.

FIG. 1 illustrates that the case 150 is a pouch type case and the secondary battery 10 is a pouch-type secondary battery, but the present disclosure is not limited thereto. The secondary battery 10 may be any type of secondary battery, such as a prismatic-type secondary battery or a cylindrical-type secondary battery.

The secondary battery 10 may be a lithium secondary battery, a sodium secondary battery, etc. However, the present disclosure is not limited thereto, and the secondary battery 10 includes any battery that is capable of repeatedly providing electricity through charging and discharging.

FIG. 2 schematically illustrates an electrode 200 for a secondary battery according to one or more embodiments of the present disclosure.

The electrode 200 for a secondary battery may include a so-called composite substrate having a structure including a first substrate 212 and a second substrate 216 each including a conductive metal material, and an insulating layer 214 between the first substrate 212 and the second substrate 216. The “composite substrate” disclosed in the present disclosure may refer to a substrate of the electrode for a secondary battery having the structure described above. A coating portion may be formed by applying a first active material layer 218 on the first substrate 212 of the composite substrate and applying a second active material layer 220 on the second substrate 216.

According to one or more embodiments of the present disclosure, the electrode 200 for a secondary battery may serve as a negative electrode. At this time, the conductive metal material forming the first substrate 212 and the second substrate 216 may include a foil composed of a conductive metal material such as copper, a copper alloy, nickel, and/or a nickel alloy. The insulating layer 214 may be made of an insulating material or polymer including PET, PP, PE, PS, PI, and/or PU.

According to one or more embodiments of the present disclosure, in a case where the electrode 200 for a secondary battery functions as a negative electrode, the mass of the insulating layer 214 in the composite substrate may be greater than the mass of the conductive metal material, such as copper, which forms the first substrate 212 and the second substrate 216. In one or more embodiments, the thickness of the insulating layer 214 in the composite substrate may be greater than the thickness of the conductive metal material, such as copper, which forms the first substrate 212 and the second substrate 216.

According to one or more embodiments of the present disclosure, the electrode 200 for a secondary battery may serve as a positive electrode. At this time, the conductive metal material forming the first substrate 212 and the second substrate 216 may include a foil composed of a conductive metal material such as aluminum or an aluminum alloy. The insulating layer 214 may be made of an insulating material or polymer including PET, PP, PE, PS, PI, and/or PU.

According to one or more embodiments of the present disclosure, in a case where the electrode 200 for a secondary battery functions as a positive electrode, the mass of the insulating layer 214 in the composite substrate may be greater than the mass of the conductive metal material, such as aluminum, which forms the first substrate 212 and the second substrate 216. In one or more embodiments, the thickness of the insulating layer 214 in the composite substrate may be greater than the thickness of the conductive metal material, such as aluminum, which forms the first substrate 212 and the second substrate 216.

According to one or more embodiments of the present disclosure, the first active material layer 218 may be applied on the first substrate 212, and the second active material layer 220 may be applied on the second substrate 216. The first active material layer 218 and the second active material layer 220 may form a coating portion of the electrode 200 for a secondary battery. The first active material layer 218 and the second active material layer 220 may include a transition metal oxide, etc.

According to one or more embodiments of the present disclosure, the electrode 200 for a secondary battery may further include an uncoated portion in which no active material layer is applied on both the first substrate 212 and the second substrate 216 of the composite substrate 210 at any location along the longitudinal direction of the electrode 200 for a secondary battery.

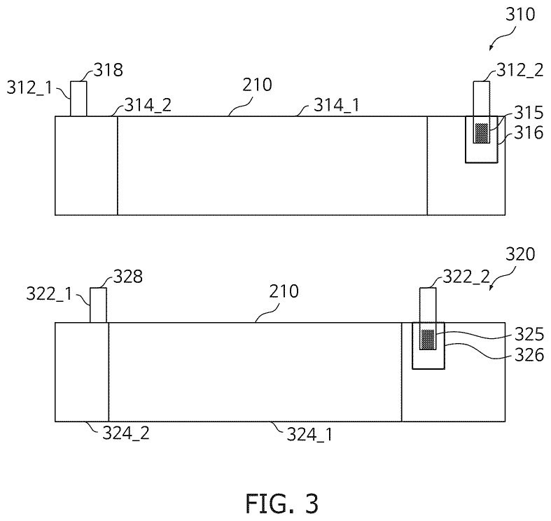

Various embodiments of the electrode 200 for a secondary battery including the composite substrate are disclosed in FIGS. 3-6 below and are described below, but the electrode 200 for a secondary battery may further include electrode tabs joined to the first substrate 212 and the second substrate 216 of the composite substrate. Each electrode tab may be joined to the uncoated portion by welding or the like to form a joined portion. In one or more embodiments, each electrode tab may have a protection tape attached to cover the joined portion.

In general, in a case where the electrode 200 for a secondary battery includes a composite substrate, the electrode 200 is insulated by the insulating layer 214. Accordingly, two electrode tabs have to be joined to opposite surfaces of the uncoated portions of the first substrate 212 and the second substrate 216 with the insulating layer 214 provided therebetween, and then, the two electrode tabs facing each other have to be welded. Therefore, a larger number of electrode tabs may be used in comparison to an electrode for a conventional secondary battery by using a single substrate made of only a conductive metal material. Hereinafter, various types of electrode structures for a secondary battery having a composite substrate including a smaller number of electrode tabs than a conventional technique are discussed according to one or more embodiments of the present disclosure.

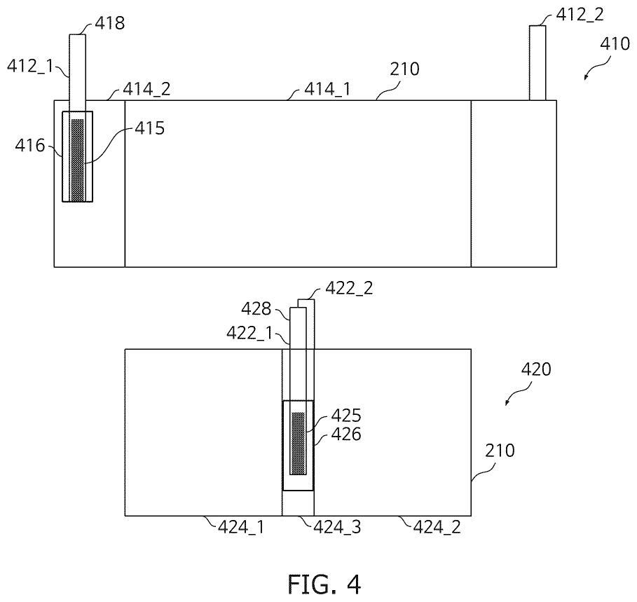

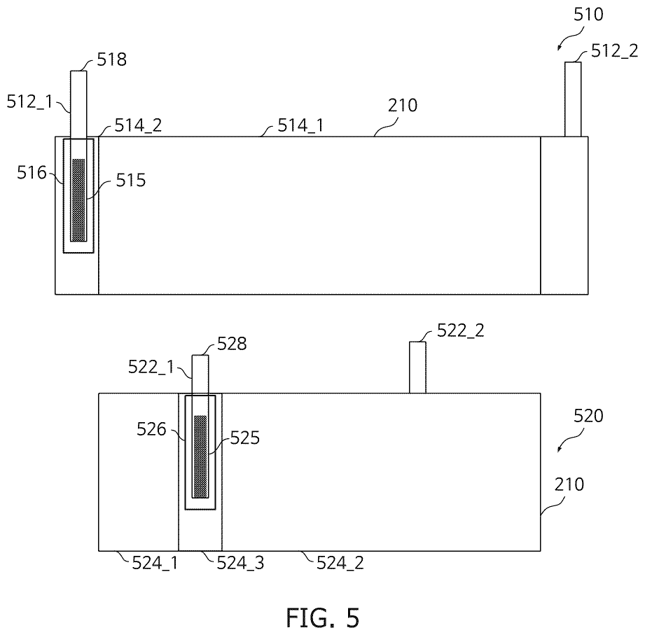

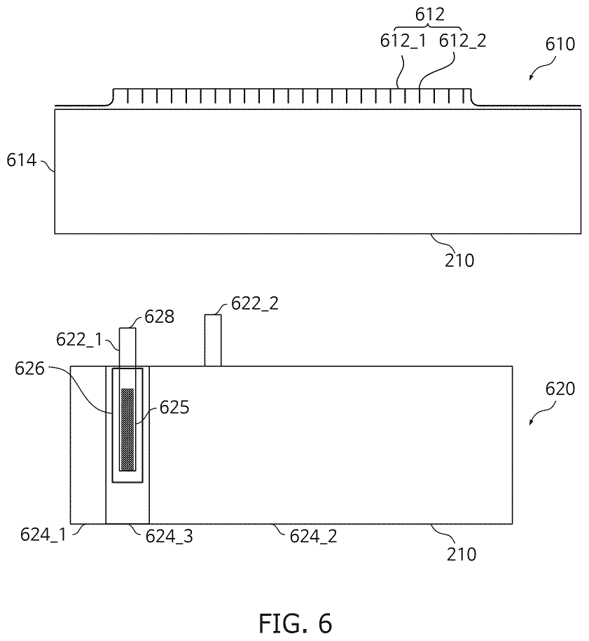

FIG. 3 illustrates an electrode for a secondary battery according to a first embodiment of the present disclosure, FIG. 4 illustrates an electrode for a secondary battery according to a second embodiment of the present disclosure, FIG. 5 illustrates an electrode for a secondary battery according to a third embodiment of the present disclosure, and FIG. 6 illustrates an electrode for a secondary battery according to a fourth embodiment of the present disclosure.

Referring to FIG. 3, a first electrode 310 and a second electrode 320 may include the composite substrate 210 disclosed in FIG. 2. According to one or more embodiments of the present disclosure, the first electrode 310 and the second electrode 320 may be formed by applying an active material layer to opposite surfaces of the composite substrate 210, and the lengths of the regions where the active material layer is applied may be different from each other. According to one or more embodiments of the present disclosure, one surface and the other surface refer to opposite sides of the electrode, and one end and the other end refer to opposite ends of the electrode with respect to the longitudinal direction.

According to one or more embodiments of the present disclosure, an active material layer may not be applied to both ends of one surface and the other surface of the composite substrate 210 in the first electrode 310 and the second electrode 320, so that a region in which the composite substrate 210 is exposed may be formed. The lengths of the exposed regions of the composite substrate 210 formed at both ends of one surface and the other surface of the composite substrate 210 with respect to the longitudinal direction of the composite substrate 210 may be equal to or different from each other. Accordingly, the first electrode 310 and the second electrode 320 may include coated portions 314_1 and 324_1 in which an active material layer is applied to both surfaces of the composite substrate 210 and uncoated portions 314_2 and 324_2 in which an active material layer is not applied to opposite surfaces of the composite substrate 210. According to one or more embodiments of the present disclosure, the uncoated portions 314_2 and 324_2 may be positioned at opposite ends of the composite substrate 210. According to one or more embodiments of the present disclosure, the lengths of the uncoated portions 314_2 positioned at opposite ends of the first electrode 310 may be different from each other with respect to the longitudinal direction of the composite substrate 210, and the lengths of the uncoated portions 324_2 positioned at opposite ends of the second electrode 320 may be different from each other with respect to the longitudinal direction of the composite substrate 210.

According to one or more embodiments of the present disclosure, the first electrode 310 may include a joined portion 315 formed by joining the electrode tabs 312_1 and 312_2 to the uncoated portion 314_2. For example, the electrode tab 312_1 may be joined at an arbitrary position on the uncoated portion 314_2 formed on one surface of the first electrode 310 to form the joined portion 315, and the electrode tab 312_2 may be joined at an arbitrary position on the uncoated portion 314_2 formed on the other surface opposite to one surface of the first electrode 310 to form the joined portion 315. According to one or more embodiments of the present disclosure, the electrode tab 312_1 and the electrode tab 312_2 may be positioned at different positions that do not face each other, and then may be joined to the uncoated portions 314_2 on one surface and the other surface of the first electrode 310, respectively, to form the joined portion 315. In other words, the electrode tab 312_1 may be joined to the uncoated portion 314_2 formed at one end of the first electrode 310 on one surface of the first electrode 310 to form the joined portion 315, and the electrode tab 312_2 may be joined to the uncoated portion 314_2 formed at the other end of the first electrode 310 on the other surface of the first electrode 310 to form the joined portion 315. Accordingly, in one or more embodiments of the present disclosure, the electrode tab 312_1 may be positioned at one end with respect to the longitudinal direction of the composite substrate 210, and the electrode tab 312_2 may be positioned at the other end with respect to the longitudinal direction of the composite substrate 210.

According to one or more embodiments of the present disclosure, the electrode tabs 312_1 and 312_2 may be joined to the uncoated portion 314_2 formed at one end or the other end of the first electrode 310 through a process such as welding to form the joined portion 315. For example, the electrode tabs 312_1 and 312_2 may be joined to the uncoated portion 314_2 of the first electrode 310 through laser welding, ultrasonic welding, and/or the like to form the joined portion 315.

According to one or more embodiments of the present disclosure, the first electrode 310 may further include a protection tape 316 covering the joined portions 315 of the electrode tabs 312_1 and 312_2. According to one or more embodiments of the present disclosure, the protection tape 316 may include a rectangular film shape. According to one or more embodiments of the present disclosure, the protection tape 316 may include at least one insulating material such as polytetrafluoroethylene (PTFE) (Teflon), PP, or PE. Teflon(R) is a registered trademark of Chemours Company FC, LLC, Wilmington, Delaware. According to one or more embodiments of the present disclosure, the protection tape 316 may prevent the first electrode 310 from being damaged by the electrode tabs 312_1 and 312_2 and protect the joined portions 315, which are portions where the electrode tabs 312_1 and 312_2 are joined by welding and/or the like.

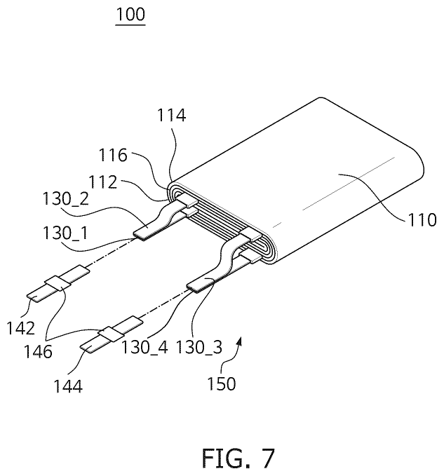

According to one or more embodiments of the present disclosure, at least a portion of the electrode tabs 312_1 and 312_2 may protrude from one side of the composite substrate 210. For example, as shown in FIG. 3, the electrode tabs 312_1 and 312_2 may include a protrusion 318 protruding from one side of the composite substrate 210. The length of the protrusion 318 of the electrode tab 312_1 and the length of the protrusion 318 of the electrode tab 312_2 may be equal to or different from each other. For example, the length of the protrusion 318 of the electrode tab 312_1 may be longer than the length of the protrusion 318 of the electrode tab 312_2. The protrusions 318 of the electrode tabs 312_1 and 312_2 may be joined to each other and may be electrically connected to a lead tab or terminal of the secondary battery according to one or more embodiments of the present disclosure. This is described in detail below with reference to FIG. 7.

According to one or more embodiments of the present disclosure, the electrode tab 312_1 joined to one surface of the first electrode 310 may be electrically connected to an active material layer formed on one surface of the first electrode 310 (e.g., corresponding to the first active material layer 218 in FIG. 2), and the electrode tab 312_2 joined to the other surface of the first electrode 310 may be electrically connected to an active material layer formed on the other surface of the first electrode 310 (e.g., corresponding to the second active material layer 220 in FIG. 2).

According to one or more embodiments of the present disclosure, the electrode tabs 312_1 and 312_2 may include a conductive metal material such as copper, a copper alloy, nickel, and/or a nickel alloy.

According to one or more embodiments of the present disclosure, the second electrode 320 may include a joined portion 325 formed by joining the electrode tabs 322_1 and 322_2 to the uncoated portion 324_2. For example, the electrode tab 322_1 may be joined at an arbitrary position on the uncoated portion 324_2 formed on one surface of the second electrode 320 to form the joined portion 325, and the electrode tab 322_2 may be joined at an arbitrary position on the uncoated portion 324_2 formed on the other surface opposite to one surface of the second electrode 320 to form the joined portion 325. According to one or more embodiments of the present disclosure, the electrode tab 322_1 and the electrode tab 322_2 may be positioned at different positions that do not face each other, and then may be joined to the uncoated portions 324_2 on one surface and the other surface of the second electrode 320, respectively, to form the joined portion 325. In other words, the electrode tab 322_1 may be joined to the uncoated portion 324_2 formed at one end of the second electrode 320 on one surface of the second electrode 320 to form the joined portion 325, and the electrode tab 322_2 may be joined to the uncoated portion 324_2 formed at the other end of the second electrode 320 on the other surface of the second electrode 320 to form the joined portion 325. Accordingly, in one or more embodiments of the present disclosure, the electrode tab 322_1 may be positioned at one end with respect to the longitudinal direction of the composite substrate 210, and the electrode tab 322_2 may be positioned at the other end with respect to the longitudinal direction of the composite substrate 210.

According to one or more embodiments of the present disclosure, the electrode tabs 322_1 and 322_2 may be joined to the uncoated portion 324_2 formed at one end or the other end of the second electrode 320 through a process such as welding to form the joined portion 325. For example, the electrode tabs 322_1 and 322_2 may be joined to the uncoated portion 324_2 of the second electrode 320 through laser welding, ultrasonic welding, and/or the like to form the joined portion 325.

According to one or more embodiments of the present disclosure, the second electrode 320 may further include a protection tape 326 covering the joined portions 325 of the electrode tabs 322_1 and 322_2. According to one or more embodiments of the present disclosure, the protection tape 326 may include a rectangular film shape. According to one or more embodiments of the present disclosure, the protection tape 326 may include at least one insulating material such as Teflon, PP, or PE. According to one or more embodiments of the present disclosure, the protection tape 326 may prevent the second electrode 320 from being damaged by the electrode tabs 322_1 and 322_2 and protect the joined portions 325, which are portions where the electrode tabs 322_1 and 322_2 are joined by welding and/or the like.

According to one or more embodiments of the present disclosure, at least a portion of the electrode tabs 322_1 and 322_2 may protrude from one side of the composite substrate 210. For example, as shown in FIG. 3, the electrode tabs 322_1 and 322_2 may include a protrusion 328 protruding from one side of the composite substrate 210. The length of the protrusion 328 of the electrode tab 322_1 and the length of the protrusion 328 of the electrode tab 322_2 may be equal to or different from each other. For example, the length of the protrusion 328 of the electrode tab 322_1 may be longer than the length of the protrusion 328 of the electrode tab 322_2. As described with respect to the embodiments disclosed in FIGS. 7-10, the protrusions 328 of the electrode tabs 322_1 and 322_2 may be joined to each other and electrically connected to the lead tab or terminal of the secondary battery disclosed in one or more of the following embodiments of the present disclosure.

According to one or more embodiments of the present disclosure, the electrode tab 322_1 joined to one surface of the second electrode 320 may be electrically connected to an active material layer formed on one surface of the second electrode 320 (e.g., corresponding to the first active material layer 218 in FIG. 2), and the electrode tab 322_2 joined to the other surface of the second electrode 320 may be electrically connected to an active material layer formed on the other surface of the second electrode 320 (e.g., corresponding to the second active material layer 220 in FIG. 2).

According to one or more embodiments of the present disclosure, the electrode tabs 322_1 and 322_2 may include a conductive metal material such as aluminum or an aluminum alloy.

According to one or more embodiments of the present disclosure, the first electrode 310 and the second electrode 320 may be alternately stacked with a separator to form a wound electrode assembly. The first electrode 310 and the second electrode 320 may be wound from either end of the composite substrate 210.

According to one or more embodiments of the present disclosure, the length of the uncoated portion 314_2 of the first electrode 310 and the length of the uncoated portion 324_2 of the second electrode 320 formed from the two ends of the electrodes may be different from each other.

According to one or more embodiments of the present disclosure, the first electrode 310 may serve as a negative electrode of the secondary battery, and the second electrode 320 may serve as a positive electrode of the secondary battery.

Referring to FIG. 4, an electrode for a secondary battery according to one or more other embodiments (e.g., a second embodiment) of the present disclosure has the same structure as the electrode for a secondary battery according to the first embodiment (e.g., the embodiment of FIG. 3) described above, except for a structure of a second electrode 420, and therefore, a redundant description of the same structure is omitted.

For example, according to one or more embodiments of the present disclosure, in the first electrode 410 of FIG. 4, a coated portion 414_1 may be similar to the coated portions 314_1 and 324_1 of FIG. 3, the uncoated portions 414_2 may be similar to the uncoated portions 314_2 and 324_2 of FIG. 3, the electrode tabs 412_1 and 412_2 may be similar to the electrode tabs 312_1 and 312_2 of FIG. 3, a protrusion 418 may be similar to the a protrusion 318 of FIG. 3, a joined portion 415 may be similar to the joined portion 315 of FIG. 3, and a protection tape 416 may be similar to the protection tape 316 of FIG. 3. As such, redundant description may be omitted.

According to one or more embodiments of the present disclosure, the second electrode 420 may be formed by applying an active material layer to opposite surfaces of a composite substrate 210, and the length of a region where the active material layer is applied on one surface of the second electrode 420 and the length of a region where the active material layer is applied on the other surface of the second electrode 420 may be substantially equal to each other.

According to one or more embodiments of the present disclosure, the active material layer may not be applied to the central portions of one surface and the other surface of the composite substrate 210 in the second electrode 420, so that a region in which the composite substrate 210 is exposed may be formed. Accordingly, the second electrode 420 may include a first coated portion 424_1 on which an active material layer (according to one or more embodiments of the present disclosure, an active material layer applied with such a structure may be referred to as a 1_1 active material layer) is applied at a suitable distance (e.g., a predetermined distance) from one end on one surface with respect to a region where the composite substrate 210 is exposed, and a second coated portion 424_2 on which an active material layer (according to one or more embodiments of the present disclosure, an active material layer applied with such a structure may be referred to as a 2_2 active material layer) is applied at a suitable distance (e.g., a predetermined distance) from the other end on one surface thereof. Accordingly, the second electrode 420 may include a first coated portion 424_1 on which an active material layer (according to one or more embodiments of the present disclosure, an active material layer applied with such a structure may be referred to as a 2_1 active material layer) is applied at a suitable distance (e.g., a predetermined distance) from one end on the other surface with respect to a region where the composite substrate 210 is exposed, and a second coated portion 424_2 on which an active material layer (according to one or more embodiments of the present disclosure, an active material layer applied with such a structure may be referred to as a 2_2 active material layer) is applied at a suitable distance (e.g., a predetermined distance) from the other end on the other surface thereof. The lengths of the 1_1 active material layer and the 2_1 active material layer described above may be equal (or substantially equal) to each other, and the lengths of the 1_2 active material layer and the 2_2 active material layer may be equal (or substantially equal) to each other.

According to one or more embodiments of the present disclosure, the active material layer may not be applied to the central portions of one surface and the other surface of the composite substrate 210 in the second electrode 420, so that an uncoated portion 424_3 in which the composite substrate 210 is exposed may be formed. According to one or more embodiments of the present disclosure, the uncoated portion 424_3 may be positioned at the central portion of the composite substrate 210. According to one or more embodiments of the present disclosure, electrode tabs 422_1 and 422_2 may be joined to the uncoated portion 424_3 of the second electrode 420 to form a joined portion 425.

According to one or more embodiments of the present disclosure, the electrode tab 422_1 may be provided between the 1_1 active material layer and the 1_2 active material layer described above on one surface of the second electrode 420 and may be joined to the uncoated portion 424_3 to form a joined portion 425.

According to one or more embodiments of the present disclosure, the electrode tab 422_2 may be provided between the 2_1 active material layer and the 2_2 active material layer described above on the other surface of the second electrode 420 and may be joined to the uncoated portion 424_3 to form a joined portion 425. As shown in FIG. 4, the electrode tab 422_1 and the electrode tab 422_2 may face each other on the second electrode 420.

According to one or more embodiments of the present disclosure, the first electrode 410 and the second electrode 420 may be alternately stacked with a separator to form a wound electrode assembly. The first electrode 410 and the second electrode 420 may be wound from either end of the composite substrate 210.

According to some embodiments of the present disclosure, the first electrode 410 may serve as a negative electrode of the secondary battery disclosed in some embodiments of the present disclosure, and the second electrode 420 may serve as a positive electrode of the secondary battery disclosed in some embodiments of the present disclosure.

Referring to FIG. 5, an electrode for a secondary battery according to one or more embodiments (e.g., a third embodiment) of the present disclosure has the same structure as the electrode for a secondary battery according to the first and second embodiments described above, except for a structure of a second electrode 520, and therefore, a redundant description of the same structure is omitted.

For example, according to one or more embodiments of the present disclosure, in the first electrode 510 of FIG. 5, a coated portion 514_1 may be similar to the coated portions 314_1 and 324_1 of FIG. 3, the uncoated portions 514_2 may be similar to the uncoated portions 314_2 and 324_2 of FIG. 3, the electrode tabs 512_1 and 512_2 may be similar to the electrode tabs 312_1 and 312_2 of FIG. 3, a protrusion 518 may be similar to the a protrusion 318 of FIG. 3, a joined portion 515 may be similar to the joined portion 315 of FIG. 3, and a protection tape 516 may be similar to the protection tape 316 of FIG. 3. As such, redundant description may be omitted.

According to one or more embodiments of the present disclosure, the second electrode 520 may be formed by applying an active material layer to opposite surfaces of a composite substrate 210. According to one or more embodiments of the present disclosure, an active material layer is not applied to one surface and the other surface of the composite substrate 210 of the second electrode 520, and thus, a region where the composite substrate 210 is exposed may be spaced (e.g., spaced apart) from the longitudinal direction of the composite substrate 210 by a certain distance or more. Accordingly, the second electrode 520 may include a first coated portion 524_1 on which an active material layer (according to one or more embodiments of the present disclosure, an active material layer applied with such a structure may be referred to as a 1_1 active material layer) is applied at a suitable distance (e.g., a predetermined distance) from one end on one surface with respect to a region where the composite substrate 210 is exposed, and a second coated portion 524_2 on which an active material layer (according to one or more embodiments of the present disclosure, an active material layer applied with such a structure may be referred to as a 2_2 active material layer) is applied at a suitable distance (e.g., a predetermined distance) from the other end on one surface thereof. Accordingly, the second electrode 520 may include a first coated portion 524_1 on which an active material layer (according to one or more embodiments of the present disclosure, an active material layer applied with such a structure may be referred to as a 2_1 active material layer) is applied at a suitable distance (e.g., a predetermined distance) from one end on the other surface with respect to a region where the composite substrate 210 is exposed, and a second coated portion 524_2 on which an active material layer (according to one or more embodiments of the present disclosure, an active material layer applied with such a structure may be referred to as a 2_2 active material layer) is applied at a suitable distance (e.g., a predetermined distance) from the other end on the other surface thereof. The lengths of the 1_1 active material layer and the 2_1 active material layer described above may be different from each other, and the lengths of the 1_2 active material layer and the 2_2 active material layer may be different from each other.

According to one or more embodiments of the present disclosure, an active material layer is not applied to one surface and the other surface of the composite substrate 210, and thus, an uncoated portion 524_3 where the composite substrate 210 is exposed may be spaced (e.g., spaced apart) from the longitudinal direction of the composite substrate 210 by a certain distance or more.

According to one or more embodiments of the present disclosure, electrode tabs 522_1 and 522_2 may be joined to the uncoated portion 524_3 of the second electrode 520 to form a joined portion 525.

According to one or more embodiments of the present disclosure, the electrode tab 522_1 may be provided between the 1_1 active material layer and the 1_2 active material layer described above on one surface of the second electrode 520 and may be joined to the uncoated portion 524_3 to form a joined portion 525.

According to one or more embodiments of the present disclosure, the electrode tab 522_2 may be provided between the 2_1 active material layer and the 2_2 active material layer described above on the other surface of the second electrode 520 and may be joined to the uncoated portion 524_3 to form a joined portion 525. As shown in FIG. 4, the electrode tab 522_1 and the electrode tab 522_2 may be positioned at different positions with respect to the longitudinal direction of the composite substrate 210 on the second electrode 520, and then may be joined to the uncoated portion 524_3 on one surface and the other surface of the second electrode 520, respectively, to form the joined portion 525. In other words, the electrode tab 522_1 may be joined to the uncoated portion 524_3 spaced (e.g., spaced apart) from one end of the second electrode 520 on one surface of the second electrode 520 by a certain distance to form the joined portion 525, and the electrode tab 522_2 may be joined to the uncoated portion 524_3 spaced from the other end of the second electrode 520 on the other surface of the second electrode 520 by a certain distance to form the joined portion 525. According to one or more embodiments of the present disclosure, the electrode tab 522_1 and the electrode tab 522_2 may not face each other.

According to one or more embodiments of the present disclosure, the first electrode 510 and the second electrode 520 may be alternately stacked with a separator to form a wound electrode assembly. The first electrode 510 and the second electrode 520 may be wound from either end of the composite substrate 210.

According to one or more embodiments of the present disclosure, the first electrode 510 may serve as a negative electrode of the secondary battery disclosed in one or more embodiments of the present disclosure, and the second electrode 520 may serve as a positive electrode of the secondary battery disclosed in some embodiments of the present disclosure.

Referring to FIG. 6, an electrode for a secondary battery according to one or more embodiments (e.g., a fourth embodiment) of the present disclosure has the same structure as the electrode for a secondary battery according to the third embodiment described above, except for a structure of a first electrode 610, and therefore, a redundant description of the same structure is omitted.

For example, according to one or more embodiments of the present disclosure, in the second electrode 620 of FIG. 6, a coated portion 624_1 and 624_2 may be similar to the coated portions 524_1 and 524_2 of FIG. 5, the uncoated portion 624_3 may be similar to the uncoated portions 524_3 of FIG. 5, the electrode tabs 622_1 and 622_2 may be similar to the electrode tabs 522_1 and 522_2 of FIG. 5, a protrusion 628 may be similar to the a protrusion 528 of FIG. 5, a joined portion 625 may be similar to the joined portion 525 of FIG. 5, and a protection tape 626 may be similar to a protection tape 526 of FIG. 5. As such, redundant description may be omitted.

According to one or more embodiments of the present disclosure, the first electrode 610 may be formed by applying an active material layer to opposite surfaces of a composite substrate 210.

According to one or more embodiments of the present invention, one surface of the composite substrate 210 of the first electrode 610 may include a first uncoated portion 612_1 which is a region on which an active material layer is not applied to one side thereof, and the other surface of the composite substrate 210 of the first electrode 610 may include a second uncoated portion 612_2 which is a region on which an active material layer is not applied to one side thereof. According to one or more embodiments of the present disclosure, the first uncoated portion 612_1 and the second uncoated portion 612_2 may face each other.

According to one or more embodiments of the present disclosure, the first uncoated portion 612_1 and the second uncoated portion 612_2 may be joined to each other and segmented to form a plurality of segmented portions 612. According to one or more embodiments of the present disclosure, the segmented portions 612 may be associated with electrical connection between active material layers applied on one surface and the other surface of the first electrode 610. In other words, the segmented portions 612 may function as electrode tabs in themselves (so-called tab-less structure) as disclosed with respect to one or more embodiments of the present disclosure.

According to one or more embodiments of the present disclosure, the first electrode 610 and the second electrode 620 may be alternately stacked with a separator to form a wound electrode assembly. The first electrode 610 and the second electrode 620 may be wound from either end of the composite substrate 210.

According to one or more embodiments of the present disclosure, the first electrode 610 may serve as a negative electrode of the secondary battery disclosed in one or more embodiments of the present disclosure, and the second electrode 620 may serve as a positive electrode of the secondary battery disclosed in one or more embodiments of the present disclosure.

FIG. 7 illustrates an electrode assembly 100 for a secondary battery according to one or more embodiments of the present disclosure. Referring to FIG. 7, an electrode assembly 100 for a secondary battery may be included in the secondary battery 10 shown in FIG. 1. According to one or more embodiments of the present disclosure, the electrode assembly 100 may include an electrode stack 110 formed by alternately stacking and winding first electrodes 112 and second electrodes 114 with separators 116. According to one or more embodiments of the present disclosure, the first electrode 112 may correspond to any one of the first electrodes according to the first to third embodiments disclosed in the present disclosure, and the second electrode 114 may correspond to any one of the second electrodes according to the first to third embodiments disclosed in the present disclosure.

According to one or more embodiments of the present disclosure, a first electrode tab 130_1 and a second electrode tab 130_2 may correspond to the electrode tabs of the first electrode according to the first to third embodiments disclosed in the present disclosure, and a third electrode tab 130_3 and a fourth electrode tab 130_4 may correspond to the electrode tabs of the second electrode according to the first to third embodiments disclosed in the present disclosure.

As shown in FIG. 7, the first electrode tab 130_1 and the second electrode tab 130_2 may be joined to each other to form a current flow path between the first electrode 112 and a first lead tab 142. According to one or more embodiments of the present disclosure, the first electrode tab 130_1 and the second electrode tab 130_2 may be joined by welding and/or the like. An insulating tab film 146 may be attached to the first lead tab 142.

As shown in FIG. 7, the third electrode tab 130_3 and the fourth electrode tab 130_4 may be joined to each other to form a current flow path between the second electrode 114 and a second lead tab 144. According to one or more embodiments of the present disclosure, the third electrode tab 130_3 and the fourth electrode tab 130_4 may be joined by welding and/or the like. An insulating tab film 146 may be attached to the second lead tab 144.

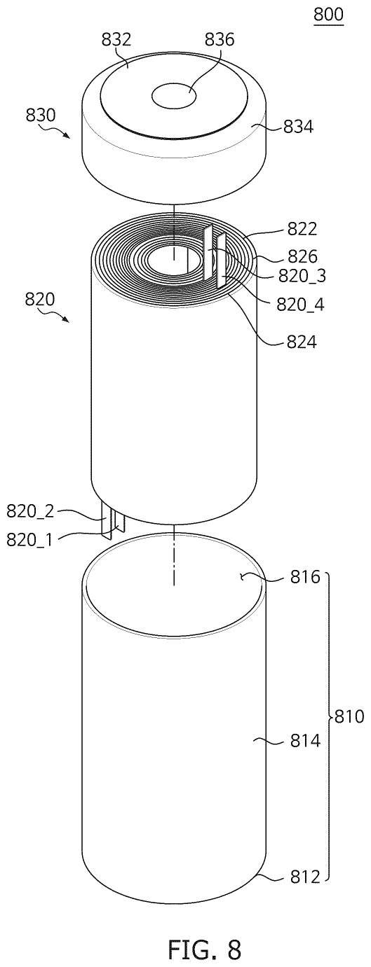

FIG. 8 illustrates a secondary battery 800 having a multi-tab structure according to one or more embodiments of the present disclosure. Referring to FIG. 8, the secondary battery 800 may include a case 810, an electrode assembly 820, and a cap assembly 830.

The case 810 may include a bottom portion 812, a side wall portion 814 connected to the bottom portion 812, and an upper end opening 816 facing the bottom portion 812. The case 810 may accommodate the electrode assembly 820 through the upper end opening 816. The upper end may refer to one end where the cap assembly 830 is provided in the longitudinal direction of the secondary battery 800. Similarly, the lower end may refer to an opposite end of the upper end in the longitudinal direction of the secondary battery 800.

According to one or more embodiments of the present disclosure, the case 810 may be formed integrally with the bottom portion 812 and the side wall portion 814. Due to this, a separate process for joining the bottom portion 812 and the side wall portion 814, which are separated from each other, in the secondary battery according to the present disclosure may not be required.

The electrode assembly 820 may include a first electrode 822 and a second electrode 824. The first electrode 822 may be a negative electrode. The second electrode 824 may be a positive electrode. According to one or more embodiments of the present disclosure, the first electrode 822 may be formed at the lower end of the electrode assembly 820, and the second electrode may be formed at the upper end of the electrode assembly 820. Of course, the opposite is also possible. In one or more embodiments, both the first electrode 822 and the second electrode 824 may be formed at the upper end of the electrode assembly 820.

According to one or more embodiments of the present disclosure, the electrode assembly 820 may be a tab-less electrode assembly. The tab-less electrode assembly may refer to an electrode assembly that does not include electrode tabs associated with the electrodes (e.g., the first electrode and the second electrode). For example, the tab-less electrode assembly may refer to an electrode assembly in which an electrode including a plurality of tabs is wound and the tabs are bent in a direction perpendicular to an axial direction, so that opposite ends of the tab-less electrode assembly form a plane perpendicular to the axial direction.

According to one or more embodiments of the present disclosure, the first electrode 822 and the second electrode 824 may include the structure of the composite substrate disclosed in FIG. 2.

The cap assembly 830 may include a terminal 832, an insulating member 834, and an electrolyte injection port 836. The terminal 832 may be electrically connected to the second electrode 824 of the electrode assembly 820.

The first electrode 822 of the electrode assembly 820 may be electrically connected to the case 810. However, the present disclosure is limited thereto, and the second electrode 824 of the electrode assembly 820 may be electrically connected to the cap assembly 830.

The insulating member 834 may insulate between the terminal 832 and the case 810. For example, the insulating member 834 may be formed to surround the terminal 832, but the present disclosure is not limited thereto, and various shapes may be used as long as the insulating member 834 may insulate the terminal 832 and the case 810.

The electrolyte injection port 836 may be formed to pass through the cap assembly 830. For example, the electrolyte injection port 836 may be formed to pass through the terminal 832. An electrolyte may be injected into the secondary battery 800 through the electrolyte injection port 836, and gas generated inside the secondary battery 800 may be discharged therethrough.

The secondary battery 800 may be a lithium secondary battery, a sodium secondary battery, etc. However, the present disclosure is not limited thereto, and the secondary battery 800 includes any battery that is capable of repeatedly providing electricity through charging and discharging.

According to one or more embodiments of the present disclosure, the electrode assembly 820 may be formed by alternately stacking and winding first electrodes 822 and second electrodes 824 with separators 826. According to one or more embodiments of the present disclosure, the first electrode 822 may correspond to any one of the first electrodes according to the first to fourth embodiments disclosed in the present disclosure, and the second electrode 824 may correspond to any one of the second electrodes according to the first to fourth embodiments disclosed in the present disclosure.

According to one or more embodiments of the present disclosure, the first electrode 822 may further include a first electrode tab 820_1 and a second electrode tab 820_2. The first electrode tab 820_1 and the second electrode tab 820_2 may correspond to the electrode tab of the first electrode according to the first to fourth embodiments disclosed in the present disclosure. According to one or more embodiments of the present disclosure, the second electrode 824 may further include a third electrode tab 820_3 and a fourth electrode tab 820_4. The third electrode tab 820_3 and the fourth electrode tab 820_4 may correspond to the electrode tab of the second electrode according to the first to third embodiments disclosed in the present disclosure.

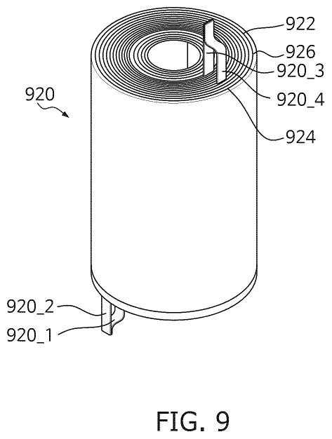

FIG. 9 illustrates an electrode assembly for a secondary battery according to one or more embodiments of the present disclosure. Referring to FIG. 9, an electrode assembly 920 may be included in the secondary battery 800 disclosed in FIG. 8 instead of the electrode assembly 820 disclosed in FIG. 8.

According to one or more embodiments of the present disclosure, the electrode assembly 920 may include a first electrode 922 and a second electrode 924. The first electrode 922 may correspond to any one of the first electrodes according to the first to third embodiments disclosed in the present disclosure, and the second electrode 924 may correspond to any one of the second electrodes according to the first to third embodiments disclosed in the present disclosure.

According to one or more embodiments of the present disclosure, the first electrode 922 may further include a first electrode tab 920_1 and a second electrode tab 920_2. The first electrode tab 920_1 and the second electrode tab 920_2 may correspond to the electrode tab of the first electrode according to the first to third embodiments disclosed in the present disclosure. The second electrode 924 may further include a third electrode tab 920_3 and a fourth electrode tab 920_4. The third electrode tab 920_3 and the fourth electrode tab 920_4 may correspond to the electrode tab of the second electrode according to the first to third embodiments disclosed in the present disclosure.

As shown in FIG. 9, at least a portion of the first electrode tab 920_1 and the second electrode tab 920_2 may protrude from one side of the first electrode 922 and may be joined to each other. According to one or more embodiments of the present disclosure, the first electrode tab 920_1 and the second electrode tab 920_2 may be joined by welding and/or the like. The first electrode tab 920_1 and the second electrode tab 920_2 joined to each other may be electrically connected to the case 810 of the secondary battery 800 disclosed in FIG. 8.

As shown in FIG. 9, at least a portion of the third electrode tab 920_3 and the fourth electrode tab 920_4 may protrude from one side of the second electrode 924 and may be joined to each other. According to one or more embodiments of the present disclosure, the third electrode tab 920_3 and the fourth electrode tab 920_4 may be joined by welding and/or the like. The third electrode tab 920_3 and the fourth electrode tab 920_4 joined to each other may be electrically connected to the terminal 832 of the secondary battery 800 disclosed in FIG. 8.

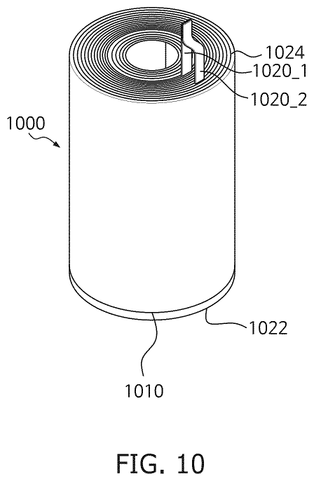

FIG. 10 illustrates an electrode assembly 1000 for a secondary battery according to one or more embodiments (e.g., a fourth embodiment) of the present disclosure. Referring to FIG. 10, the electrode assembly 1000 may be included in the secondary battery 800 disclosed in FIG. 8 instead of the electrode assembly 820 disclosed in FIG. 8.

According to one or more embodiments of the present disclosure, the electrode assembly 1000 may include a first electrode 1022 and a second electrode 1024. The first electrode 1022 may correspond to the first electrode according to the fourth embodiment disclosed in the present disclosure, and the second electrode 1024 may correspond to the second electrode according to the fourth embodiment disclosed in the present disclosure.

According to one or more embodiments of the present disclosure, the first electrode 1022 may further include a segmented portion 1010. The segmented portion 1010 may correspond to the segmented portion 612 of the first electrode according to the fourth embodiment disclosed in the present disclosure. According to one or more embodiments of the present disclosure, the segmented portion 1010 may function as an electrode tab (a so-called tab-less structure) in itself as disclosed in one or more embodiments of the present disclosure and may be electrically connected to the case 810 of the secondary battery 800 disclosed in FIG. 8.

According to one or more embodiments of the present disclosure, the second electrode 1024 may further include a first electrode tab 1020_1 and a second electrode tab 1020_2. The first electrode tab 1020_1 and the second electrode tab 1020_2 may correspond to the electrode tab of the second electrode according to the fourth embodiment disclosed in the present disclosure. As shown in FIG. 10, at least a portion of the first electrode tab 1020_1 and the second electrode tab 1020_2 may protrude from one side of the second electrode 1022 and may be joined to each other. According to one or more embodiments of the present disclosure, the first electrode tab 1020_1 and the second electrode tab 1020_2 may be joined by welding and/or the like. The first electrode tab 1020_1 and the second electrode tab 1020_2 joined to each other may be electrically connected to the terminal 832 of the secondary battery 800 disclosed in FIG. 8.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

What is claimed is:

1. An electrode for a secondary battery, the electrode comprising:
a composite substrate comprising a first substrate and a second substrate, each of the first substrate and the second substrate comprising a conductive metal material, and an insulating layer between the first substrate and the second substrate;
a first active material layer on the first substrate of the composite substrate;
a second active material layer on the second substrate of the composite substrate;
a first electrode tab coupled to the first substrate of the composite substrate; and
a second electrode tab coupled to the second substrate of the composite substrate.

2. The electrode as claimed in claim 1, wherein the first electrode tab and the second electrode tab are at different positions with respect to a longitudinal direction of the composite substrate.

3. The electrode as claimed in claim 1, wherein at least a portion of the first electrode tab protrudes from one side of the composite substrate, and
wherein at least a portion of the second electrode tab protrudes from one side of the composite substrate.

4. The electrode as claimed in claim 1, wherein the first electrode tab comprises a first protrusion, at least a portion of the first protrusion protruding from one side of the composite substrate,
wherein the second electrode tab comprises a second protrusion, at least a portion of the second protrusion protruding from one side of the composite substrate, and
wherein a length of the first protrusion is different from a length of the second protrusion.

5. The electrode as claimed in claim 4, wherein the length of the first protrusion is longer than the length of the second protrusion, and
wherein the second protrusion is coupled to the first protrusion so that the first electrode tab and the second electrode tab are electrically connected to a terminal or a lead tab.

6. The electrode as claimed in claim 1, wherein the first active material layer comprises a 1_1 active material layer and a 1_2 active material layer,
wherein the second active material layer comprises a 2_1 active material layer and a 2_2 active material layer,
wherein the first electrode tab is located between the 1_1 active material layer and the 1_2 active material layer, and
wherein the second electrode tab is located between the 2_1 active material layer and the 2_2 active material layer.

7. The electrode as claimed in claim 1, wherein the first electrode tab is located at one end with respect to a longitudinal direction of the composite material, and
wherein the second electrode tab is located at another end with respect to the longitudinal direction of the composite material.

8. The electrode as claimed in claim 1, wherein the first electrode tab is electrically connected to the first active material layer, and
wherein the second electrode tab is electrically connected to the second active material layer.

9. The electrode as claimed in claim 1, wherein the insulating layer comprises at least one of PET, PP, PE, PS, PI, or PU.

10. The electrode as claimed in claim 1, wherein the first electrode tab comprises a first joined portion coupled to the composite substrate,
wherein the second electrode tab comprises a second joined portion coupled to the composite substrate, and
wherein the electrode further comprises a protection tape covering each of the first joined portion and the second joined portion.

11. An electrode for a secondary battery, the electrode comprising:
a composite substrate comprising a first substrate and a second substrate, each of the first substrate and the second substrate comprising a conductive metal material, and an insulating layer between the first substrate and the second substrate, wherein the first substrate comprises a first uncoated portion on one side of the first substrate, the second substrate comprises a second uncoated portion on one side of the second substrate, and wherein the first uncoated portion and the second uncoated portion face each other;
a first active material layer on the first substrate of the composite substrate;
a second active material layer on the second substrate of the composite substrate; and
a plurality of segmented portions formed by joining and segmenting the first uncoated portion and the second uncoated portion.

12. The electrode as claimed in claim 11, wherein the segmented portions are associated with electrical connection between the first active material layer and the second active material layer.

13. The electrode as claimed in claim 11, wherein the insulating layer comprises at least one of PET, PP, PE, PS, PI, or PU.

14. A secondary battery comprising:
an electrode assembly comprising a positive electrode, a negative electrode and a separator; and
a case configured to accommodate the electrode assembly,
wherein the positive electrode comprises:
a first composite substrate comprising a first substrate and a second substrate, each of the first substrate and the second substrate comprising a conductive metal material, and an insulating layer between the first substrate and the second substrate;
a first active material layer on the first substrate of the first composite substrate;
a second active material layer on the second substrate of the first composite substrate;
a first electrode tab coupled to the first substrate of the first composite substrate; and
a second electrode tab coupled to the second substrate of the first composite substrate,
wherein the negative electrode comprises:
a second composite substrate comprising a third substrate and a fourth substrate, each of the third substrate and the fourth substrate comprising a conductive metal material, and an insulating layer between the third substrate and the fourth substrate, wherein the third substrate comprises a first uncoated portion on one side of the third substrate, the fourth substrate comprises a second uncoated portion on one side of the fourth substrate, and the first uncoated portion and the second uncoated portion face each other;
a third active material layer on the third substrate of the second composite substrate;
a fourth active material layer on the fourth substrate of the second composite substrate; and
a plurality of segmented portions formed by joining and segmenting the first uncoated portion and the second uncoated portion.

15. The secondary battery as claimed in claim 14, wherein a thickness of the negative electrode is less than a thickness of the positive electrode.

16. The secondary battery as claimed in claim 14, wherein the electrode assembly is formed by winding the positive electrode and the negative electrode, and the first electrode tab and the second electrode tab face each other.

17. The secondary battery as claimed in claim 14, wherein the first electrode tab and the second electrode tab are at different positions with respect to a longitudinal direction of the composite substrate.

18. The secondary battery as claimed in claim 14, wherein at least a portion of the first electrode tab protrudes from one side of the composite substrate, and
wherein at least a portion of the second electrode tab protrudes from one side of the composite substrate.
